(19) United States
(12) Patent Application Publication
(10) Pub. No.: US 2026/0201739 A1
(43) Pub. Date: Jul. 16, 2026

(54) HINGE ASSEMBLY FOR A DOOR OF AN OVERHEAD LUGGAGE COMPARTMENT

(71) Applicant: FACC AG, Ried im Innkreis (AT)

(72) Inventors: Bernhard KAMMERER, Zell an der Pram (AT); Martin ENTSFELLNER, Triftern (DE)

(21) Appl. No.: 19/135,631

(22) PCT Filed: Dec. 6, 2023
(86) PCT No.: PCT/AT2023/060430

§ 371 Date: Jun. 4, 2025

(30) Foreign Application Priority Data
Dec. 6, 2022 (AT) A 50924/2022

(51) Int. Cl. E05F 1/12; B64D 11/00; E05D 11/00

(52) U.S. Cl. CPC E05F 1/1269; B64D 11/003; E05D 11/0054; E05Y 2201/499; E05Y 2201/626; E05Y 2900/502

(57) ABSTRACT

The invention relates to a hinge assembly for a door of an overhead luggage compartment, comprising—a side cover, plate,—a lever arm for supporting the door, which is connected to the side cover plate so as to be pivotable about a pivot axis and which is pivotable between a first pivot position, which corresponds to an open position of the door, and a second pivot position, which corresponds to a closed position of the door,—a spring element connected to the lever arm to support a movement of the lever arm between the second pivot position and the first pivot position, and an adjustment element with which pretension of the spring element can be adjusted.

### CROSS REFERENCE TO RELATED APPLICATIONS

The present application is a U.S. National Phase of International Application No. PCT/AT2023/060430 entitled “HINGE ARRANGEMENT FOR A DOOR OF AN OVERHEAD LUGGAGE COMPARTMENT,” and filed on Dec. 6, 2023. International Application No. PCT/AT2023/060430 claims priority to Austrian Patent Application No. A 50924/2022 filed on Dec. 6, 2022. The entire contents of each of the above-listed applications are hereby incorporated by reference for all purposes.

### TECHNICAL FIELD

The disclosure relates to a hinge assembly for a door of an overhead luggage compartment, comprising:
a side cover plate,
a lever arm for supporting the door, which is connected to the side cover plate so as to be pivotable about a pivot axis and which is pivotable between a first pivot position, which corresponds to an open position of the door, and a second pivot position, which corresponds to a closed position of the door,
a spring element connected to the lever arm to support movement of the lever arm between the second pivot position and the first pivot position.

### BACKGROUND AND SUMMARY

Hinge assemblies are known for overhead luggage compartments, which are mounted below or above the ceiling panel or as a superstructure on the side panel, for example. However, these disadvantageously reduce the available storage space or obstruct equipment parts that are mounted on the overhead luggage compartment.

WO 2018/116084 A1 therefore proposes that the hinge assembly be provided in the side panel or an extension of the side panel of the overhead luggage compartment.

The hinge assembly should support the movement of the door of the overhead luggage compartment, for which a spring element can be provided. In particular, the hinge assembly should support the movement of the door from the closed position upwards to the open position. Once the luggage compartment housing and hinge assembly have been installed, different doors can be fitted. The different door configurations comprise, for example, different door lengths, different door protection and different locking mechanisms. The door protection can comprise, for example, a decorative film on the inside of the door or a plastic extrusion profile on the lower edge of the door to prevent damage to the door from contact with the luggage. These affect the weight and, due to their large distance from the pivot point, the torque in particular. However, the hinge assemblies provided in the side panel disadvantageously do not allow adjustment or do not comprise a sufficient adjustment range to accommodate the variations in door masses resulting from different door configurations. This results in insufficient or excessive torque being exerted by the hinge assembly on the door of the overhead luggage compartment. This could only be countered by dismantling the overhead luggage compartment and replacing the spring element if the hinge assembly allows this. However, this results in a great amount of work on the one hand and a large number of parts on the other.

The object of the invention is to alleviate or eliminate at least one of the disadvantages of the prior art. In particular, the object of the invention is to provide a hinge assembly for an overhead luggage compartment which can be used in a simple manner with different doors.

This is achieved by a hinge assembly as mentioned at the outset, whereby an adjustment element is provided with which a pretension of the spring element can be adjusted.

The pretension of the spring element can be adjusted using the adjustment element. It is therefore not necessary to replace the spring element to achieve a different pretension. By adjusting the pretension of the spring element, the force exerted on the lever arm, and thus the torque exerted by the lever arm on the door, can be adjusted. This means that the hinge assembly can be easily adapted to different provided doors with different masses.

In a preferred embodiment, a circumferential cover extends in sections along the perimeter of the side cover plate. The circumferential cover is preferably arranged essentially perpendicular to the side cover plate and/or extends from the side cover plate essentially perpendicular thereto. The circumferential cover prevents people from reaching into the hinge assembly and/or allows the hinge assembly to be attached to a side wall of a side element of the overhead luggage compartment. The circumferential cover preferably comprises a recess for the lever arm and its movement between the first and second positions. The lever arm preferably comprises an attachment section to which the door can be attached. The hinge assembly preferably comprises a stop element (end stop element), which limits a movement of the lever arm from the second pivot position to the first pivot position at the first pivot position. In this way, the stop element can prevent the lever arm from moving beyond the first pivot position. Preferably, the hinge assembly does not comprise a stop element that limits movement of the lever arm beyond the second pivot position. Movement of the door of the overhead luggage compartment in the direction of the closed position is preferably limited by the door resting against a luggage compartment housing.

Preferably, a rotation damper is provided to dampen rotation of the lever arm about the pivot axis. Preferably, the adjustment element is set up so that the pretension of the spring element is infinitely adjustable. Preferably, the adjustment element is designed to adjust the pretension of the spring element without changing the kinematics of the lever arm or the door. Preferably, when adjusting the pretension of the spring element with the adjustment element, the axis of the spring element is not changed, i.e. preferably the length of the spring element is changed with the adjustment element while the position of the axis remains the same. In particular, the kinematics are such that the door comprises a low initial opening speed. Preferably, the adjustment element is set up to adjust the pretension of the spring element at a fixed pivot position. Preferably, the adjustment element is set up to change the position of one end of the spring element in a fixed pivot position (e.g. the first or second pivot position). The adjustment element is set up to allow an adjustment of preferably at least 10 mm, particularly preferably at least 20 mm. The adjustment element is set up to shift the position of one end of the spring element in a fixed pivot position (e.g. the first or the second pivot position) within an adjustment interval of preferably at least 10 mm, particularly preferably at least 20 mm. The adjustment element is preferably connected to the spring element. Preferably, one end of the spring element is supported on the adjustment element or is held by it. Preferably, the adjustment element is supported by a counter element that is (statically) connected to the side cover plate. Preferably, at least one end of the adjustment element is supported on a counter element that is (statically) connected to the side cover plate.

The side cover plate preferably comprises holes, in particular elongated holes, for fastening to the side wall of a side element of the overhead luggage compartment. The lever arm preferably comprises holes, in particular elongated holes, for fastening the door. Elongated holes can be used in particular to compensate for manufacturing tolerances.

It is advantageous if the adjustment element comprises an adjustment unit with which the pretension of the spring element can be adjusted from outside a perimeter of the side cover plate and/or wherein the circumferential cover comprises a recess so that the adjustment unit is accessible in a direction essentially perpendicular to the side cover plate. For this purpose, the adjustment element preferably extends at least partially through the recess or the adjustment unit is arranged in such a way that it can be actuated through the recess. In this way, it is particularly easy to adapt the hinge assembly to different door masses in its mounted state. A screw head can be provided as the adjustment unit, for example. Preferably, the adjustment unit is provided adjacent to a section of the perimeter of the side cover plate, which delimits an insertion opening of a luggage compartment housing of the overhead luggage compartment. Preferably, the adjustment unit is provided in an area that is at least partially covered by the door in the closed position of the overhead luggage compartment.

The spring element is preferably set up to support a movement of the lever arm from the second pivot position into the first pivot position (at least in one area). Alternatively or additionally, the spring element can also support a movement of the lever arm from the first pivot position into the second pivot position (at least in one area). The spring element preferably causes a torque on the lever arm that is adjustable between 0.8 Nm and 1.9 Nm at the first pivot position (corresponding to the open position of the door) using the adjustment element. Preferably, the spring element holds the lever arm in the first pivot position and thus the door in the open position. Preferably, the lever arm can also be adjusted between the first pivot position and an overpivot position, which corresponds to an overpivot position of the door. In the overpivot position, the door is opened further than in the open position. Preferably, the lever arm abuts the stop element when moving from the second pivot position to the first pivot position. The stop element is preferably pivotably mounted and is preferably pretensioned by a further spring element, in particular a leg spring, and thus held in the initial position in which the lever arm abuts it in the first pivot position. The spring force of the further spring element and the spring element act in opposite directions and are such that the door is held in the open position. This means that the torque exerted by the further stop element on the spring element is greater than the torque exerted by the spring element and the weight of the door on the lever arm in the first pivot position. The door can be pushed open further from the open position by manually exerting force and brought into the overpivot position, whereby the lever arm swings the stop element out of the starting position against the spring force of the further spring. The stop element and/or a further stop element preferably blocks/block a pivoting of the lever arm beyond the overpivot position.

Preferably, fine adjustment of the opening angle is possible at the open position and/or the overpivot position. The lever arm comprises a width parallel to the pivot axis, which is preferably less than 35 mm, particularly preferably less than 25 mm.

It is preferred if the adjustment element comprises a setscrew for adjusting the pretension of the spring element. This makes it easy to adjust the pretension. The setscrew preferably comprises a screw head. Preferably, the setscrew and/or the screw head is supported on or carried by a counter element connected to the side cover plate.

It is advantageous if the adjustment element comprises a nut, in particular a barrel nut, with which the setscrew is engaged, the spring element being connected to the nut. Preferably, the nut is non-rotatably connected to the spring element, so that preferably a rotation of the setscrew causes a linear displacement of the nut, preferably so that the position or the length of one end of the spring element can be adjusted and thus the pretension of the spring element can be adjusted. Preferably, the spring element is non-rotatably mounted. If the nut is designed as a cylindrical nut, a particularly stable connection to the spring element can be achieved.

It is preferable if the first end of the spring element facing the adjustment element is designed as an eye in which the nut engages. Preferably, one end of the spring element engages around the nut on both sides of the setscrew. The spring element is preferably designed with a double eye at its end facing the adjustment element in order to grip the nut on both sides of the setscrew. The spring element is preferably formed at its end facing the adjustment element in such a way that the adjustment element exerts a force centrally on the spring axis of the spring element.

It is advantageous if the setscrew comprises a screw head. The circumferential cover preferably comprises a recess so that a rotary drive of the screw head is accessible in a direction essentially perpendicular to the side cover plate. The rotary drive of the screw head is preferably accessible from a direction essentially perpendicular to the side cover plate from outside a perimeter of the side cover plate and/or is provided at least partially outside a perimeter of the side cover plate (i.e. outside the volume extending perpendicularly away from the side cover plate). Thus, even when the hinge assembly is mounted in the overhead luggage compartment, the pretension can be easily adjusted.

It is preferred if a counter element extends along a section of the perimeter of the side cover plate essentially perpendicular to the side cover plate, with the screw head of the setscrew being supported on the counter element. Preferably, the circumferential cover forms the counter element. The counter element or the circumferential cover may comprise a projection so that the screw head is at least partially, preferably completely, recessed in the counter element or the circumferential cover.

It is preferred if the lever arm comprises a first arm element and a second arm element opposite the first arm element with respect to the pivot axis (or extending in a different direction with respect to the first arm element with respect to the pivot axis), wherein the first arm element is set up to support the door and the spring element is connected to the second arm element. The spring element thus engages with the second arm element. The spring element and the door are connected to the lever arm on opposite sides with respect to the pivot axis.

It is advantageous if the spring element comprises a spring section and a (particularly straight) connection section, with the connection section connecting the spring section to the lever arm. The spring section, which causes the spring force, is thus preferably at a distance from the attachment point of the spring element on the lever arm. In the spring section, the spring element usually comprises a larger cross-section than in the straight connection section. Thus, the provision of a connection section prevents the spring element from colliding with the pivot axis when the lever arm is pivoted. The straight connection section is preferably formed by a wire element. Preferably, the spring section is formed with a wire element, and preferably the connection section is an extension of this wire element. To connect the connection section to the lever arm, the spring element preferably comprises an eye. The connection section is preferably not essentially elastically deformed during the movement of the lever arm. The connection section preferably transmits the movement of the lever arm to the spring section. The connection section may comprise a length of at least 15 mm, preferably at least 20 mm, in particular from 30 mm to 50 mm.

The adjustment element is preferably located in a spring axis of the spring element. In this design, the longitudinal axes of the adjustment element and the spring element are essentially arranged in a line. The spring axis is parallel to the spring force exerted by the spring element. The adjustment element is preferably set up to shift the position of one end of the spring element parallel to the axis of the spring element when adjusting the pretension of the spring element. The adjustment element is preferably set up to adjust the pretension of the spring element without changing the axis of the spring element. This ensures that the kinematics of the lever arm are not changed when the pretension is changed. The adjustment element preferably runs parallel to the straight connection section. The straight connection section preferably runs parallel to the spring axis of the spring section. Preferably, the spring element comprises a wire spring and the adjustment element, in particular the wire screw, extends partially within the wire spring. Preferably, the adjustment element, the spring section and the force transmission point between the connection section and the lever arm are essentially in line.

It is preferred if the connection section is integral with the spring section. Preferably, the spring element from a (in particular eye-shaped) connecting element to the lever arm to a (in particular eye-shaped) connecting element to the adjustment element is made in one piece, in particular formed from a piece of wire.

It is preferred if the connection section extends from a side of the end of the spring section on the connection section side that faces away from the pivot axis. It is preferred if the connection section extends from that half, in particular that quarter, preferably that point, of the end of the spring section on the connection section side which faces away from the pivot axis. It is advantageous if the end of the spring section on the connection section side comprises a perimeter in cross-section normal to the spring force direction and the connection section extends from an area (that half, in particular that quarter) of a perimeter of the spring section that faces away from the pivot axis. This results in the connection section extending from the side of the end of the spring section on the connection section side facing away from the pivot axis, whereby a collision of the spring element with the pivot axis is better avoided. The spring element preferably comprises a helical spring, in particular the spring section is preferably helical spring-shaped. The connection section extends from the end of the helical spring on the connection section side, in particular at a point facing away from the pivot axis.

It is preferable if the lever arm comprises a rotatably mounted bushing to which the spring element is connected. For this purpose, the spring element preferably comprises a connection section, in particular a bent one, which comprises the bushing.

It is preferred if the lever arm comprises a pin and the bushing is rotatably mounted on the pin.

It is advantageous if the spring element comprises a tension spring.

The spring element is preferably a linear spring.

The spring element preferably comprises a (particularly oval) wire spring. The spring section is preferably designed as a linear spring, tension spring and/or (in particular oval) wire spring. The oval wire makes it possible to achieve a smaller size or a larger number of windings over the same length. In addition, a better eye strength and greater stability against permanent loads is achieved.

The disclosure further relates to a side element for an overhead luggage compartment, comprising a side wall and, adjacent to a portion of the perimeter of the side wall, a hinge assembly in one of the embodiments described in this disclosure. The side element is provided to laterally delimit the overhead luggage compartment. In this regard, a portion of a perimeter of the side element delimits the insertion opening of the overhead luggage compartment. Preferably, the adjustment element is set up to be adjusted when the hinge assembly is connected to the side wall to form the side element.

The disclosure further relates to an overhead luggage compartment for an aircraft comprising a luggage compartment housing defining a storage space, with an insertion opening through which the storage space can be loaded, wherein the luggage compartment housing comprises at least one side element as described above, wherein the lever arm of the side element carries a door which is movable between the closed position, in which the storage space is closed, and the open position, in which the storage space is accessible. In the closed position, luggage is particularly prevented from falling out of the storage space. Preferably, the overhead luggage compartment comprises a second hinge assembly, in particular a second side element with a second hinge assembly, wherein the lever arm of the second hinge assembly or the second hinge assembly of the second side element also supports the door. The overhead luggage compartment may also comprise more than two hinge assemblies and/or more than one door. In particular, the overhead luggage compartment may comprise at least one hinge assembly arranged in the area of the insertion opening. For example, the overhead luggage compartment may comprise two side elements, each with a hinge assembly, and two central hinge assemblies, wherein the overhead luggage compartment comprises two doors, each of which is supported by a hinge assembly of a side element and a central hinge assembly.

The disclosure further relates to an aircraft having at least one overhead luggage compartment in one of the embodiments described above.

In one variant, the invention also relates to a hinge assembly for a door of an overhead luggage compartment, comprising
a side cover plate,
a lever arm for supporting the door, which is connected to the side cover plate so as to be pivotable about a pivot axis and which is pivotable between a first pivot position, which corresponds to an open position of the door, and a second pivot position, which corresponds to a closed position of the door,
a spring element connected to the lever arm, to support movement of the lever arm between the second pivot position and the first pivot position, the spring element comprising a spring section and a straight connection section, the connection section connecting the spring section to the lever arm. Thus, a collision between the spring element and the pivot axis is avoided. The preferred embodiments described in this disclosure may also be provided in this variant.

The invention is further explained below with reference to a preferred embodiment shown in the drawings.

### BRIEF DESCRIPTION OF THE FIGURES

FIG. 1 schematically shows a preferred embodiment of the hinge assembly.

FIG. 2 shows a detailed view of a spring element of the embodiment of FIG. 1.

FIG. 3 shows a detailed view of an adjustment element of the embodiment of FIG. 1.

FIG. 4 shows a detailed view of a lever arm of the embodiment of FIG. 1.

FIG. 5 shows an overhead luggage compartment with the hinge assembly of the embodiment of FIG. 1 in an open position.

FIG. 6 shows the overhead luggage compartment of FIG. 5 in an overpivot position.

### DETAILED DESCRIPTION

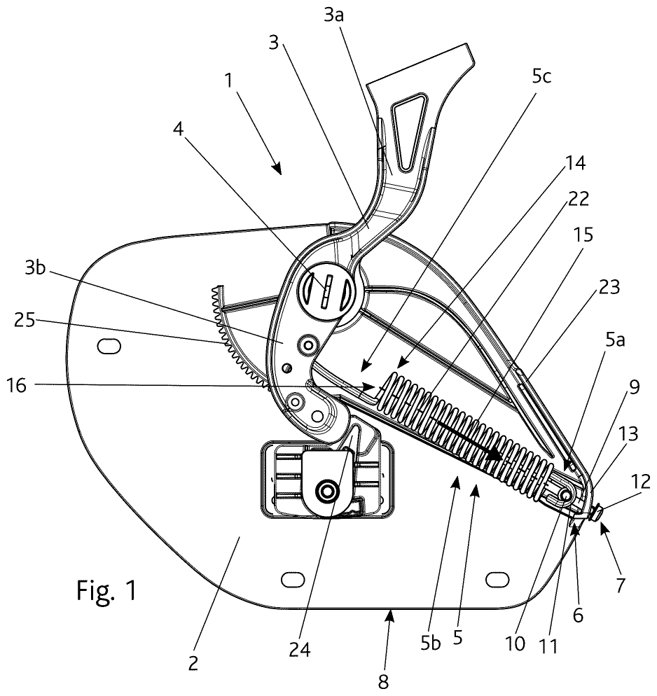

FIGS. 1 to 4 show a preferred embodiment of a hinge assembly 1 for a door of an overhead luggage compartment mounted in an aircraft cabin of an aircraft. Therein, FIG. 1 schematically shows a side view of the hinge assembly 1. The hinge assembly comprises a mounting or side cover plate 2, which delimits the hinge assembly in the direction of a storage space of the overhead luggage compartment. A second side cover plate opposite this first side cover plate 2 may also be provided. However, this is not necessary, especially if the overhead luggage compartment is directly adjacent to another overhead luggage compartment.

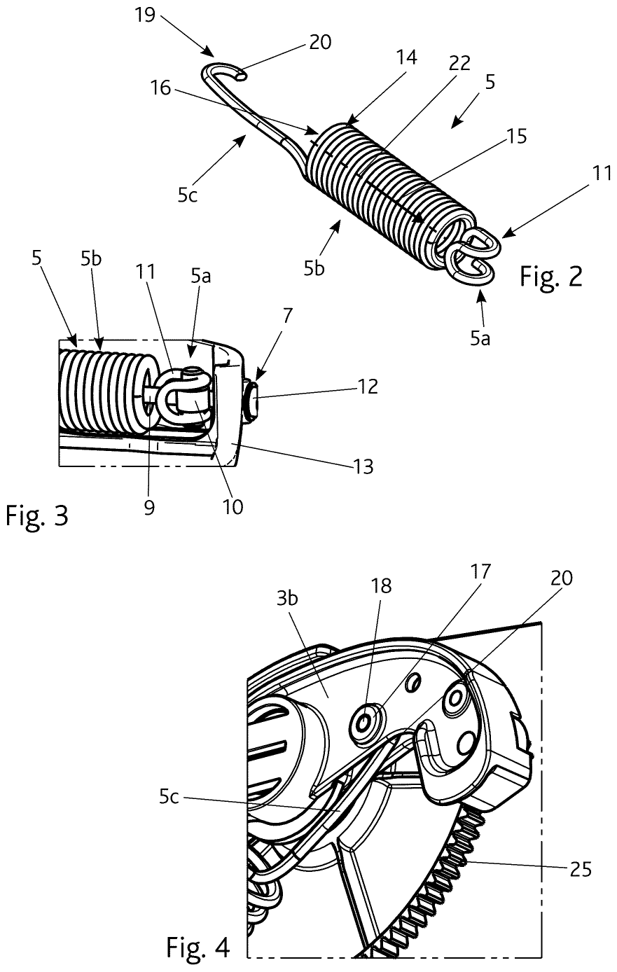

The hinge assembly 1 comprises a lever arm 3 for supporting the door. The lever arm 3 is pivotably connected to the side cover plate 2 about a pivot axis 4 and is pivotable between a first pivot position, which corresponds to an open position of the door, and a second pivot position, which corresponds to a closed position of the door. The lever arm 3 can be pivoted further from the open position into an overpivot position about the pivot axis 4, which corresponds to an overpivot position of the door. In FIG. 1, the lever arm 3 is shown in the overpivot position. The hinge assembly comprises a spring element 5, which is connected to the lever arm 3 to support a movement of the lever arm 3 between the second pivot position and the first pivot position. The spring element 5 thus supports the lifting of the door from the closed position to the open position. FIG. 2 shows a detailed view of the spring element 5.

The hinge assembly comprises an adjustment element 6, which can be used to adjust the pretension of the spring element 5. This makes it easy to adapt the support provided to different door masses. In the case of a heavy door, for example, the pretension can be increased so that a greater torque is applied to the lever arm and thus the door. The adjustment element 6 runs along a spring axis 22 of the spring element 5. FIG. 3 shows a detailed view of the adjustment element 6.

A circumferential cover 23 extends in sections along a perimeter 8 of the side cover plate 2. The circumferential cover 23 extends from the side cover plate 2 essentially perpendicular thereto. The adjustment element 6 comprises an adjustment unit 7 with which the pretension of the spring element 5 can be adjusted from outside the perimeter 8 of the side cover plate 2 (i.e. from outside a volume extending from the side cover plate 2 perpendicularly thereto). The circumferential cover 23 comprises a recess so that the adjustment unit 7 is accessible in a direction essentially perpendicular to the side cover plate 2. For this purpose, in this embodiment the adjustment element 6 extends at least partially through the recess, which means that in this embodiment the adjustment unit 7 is located outside the perimeter 8 of the side cover plate 2. This allows the pretension to be easily adjusted even when the hinge assembly 1 is mounted. Preferably, the hinge assembly 1 is located on a front side of the hinge assembly in the assembled state of the overhead luggage compartment, i.e. on a side from which the overhead luggage compartment is loaded. In particular, the adjustment unit 7 adjoins a part of the perimeter 8 of the side cover plate 2 which delimits an insertion opening of the overhead luggage compartment.

The adjustment element 6 comprises a setscrew 9 for adjusting the pretension of the spring element 5. A nut 10 is provided on the setscrew 9, which in this embodiment is designed as a cylindrical nut. The position of the nut 10 can be shifted by turning the setscrew 9. The spring element 5 is connected to the nut 10 so that the pretension of the spring element 5 can be adjusted. The spring element 5 is formed at a first end 5a as an eye 11 in which the nut 10 engages. In particular, the first end 5a comprises a double eye shape, so that the nut 11 is encompassed by the first end 5a on both sides in relation to the setscrew 9 (cf. FIGS. 2 and 3). As adjustment unit 7, a screw head 12 of the setscrew 9 is provided at least partially outside a perimeter 8 of the side cover plate 2. The adjustment unit 7 can also be provided to be recessed in the side cover 23. The side cover 23 forms a counter element 13, whereby the screw head 12 of the setscrew 9 is supported on the counter element 13.

The lever arm 3 comprises a first arm element 3a and a second arm element 3b opposite the first arm element 3a with respect to the pivot axis 4. The first arm element 3a is set up to support the door and the spring element 5 is connected to the second arm element 3b. The door and the spring element 5 are thus connected to the lever arm 3 on different sides with respect to the pivot axis 4.

The spring element 5 comprises a spring section 5b and a straight connection section 5c, with the connection section 5c connecting the spring section 5b to the lever arm 3. The connection section 5c is integral with the spring section 5b. The end 14 of the spring section 5b on the connecting section side comprises a perimeter 16 in cross-section normal to the spring force direction 15. The connection section 5c extends from an area of the perimeter 16 of the spring section 5b that faces away from the pivot axis 4. Thus, from the end 14 of the spring section 5b facing the lever arm 3, the connection section 5c adjoins the spring section 5b or its perimeter 16 on that side (in particular in that half or in that quarter or at that point) which faces away from the pivot axis, i.e. which faces away from the door in the mounted state.

As can be seen more clearly in FIG. 4, the lever arm 3 comprises a rotatably mounted bushing 17 to which the spring element 5 is connected. The bushing 17 is rotatably mounted on a pin 18. At its end 19 on the lever arm side, the spring element comprises a curved connecting section 20 (cf. FIG. 2; largely concealed in FIG. 4), which encompasses the bushing 17 on the circumferential side. This allows the spring element 5 to engage with the lever arm 3 regardless of its pivot position.

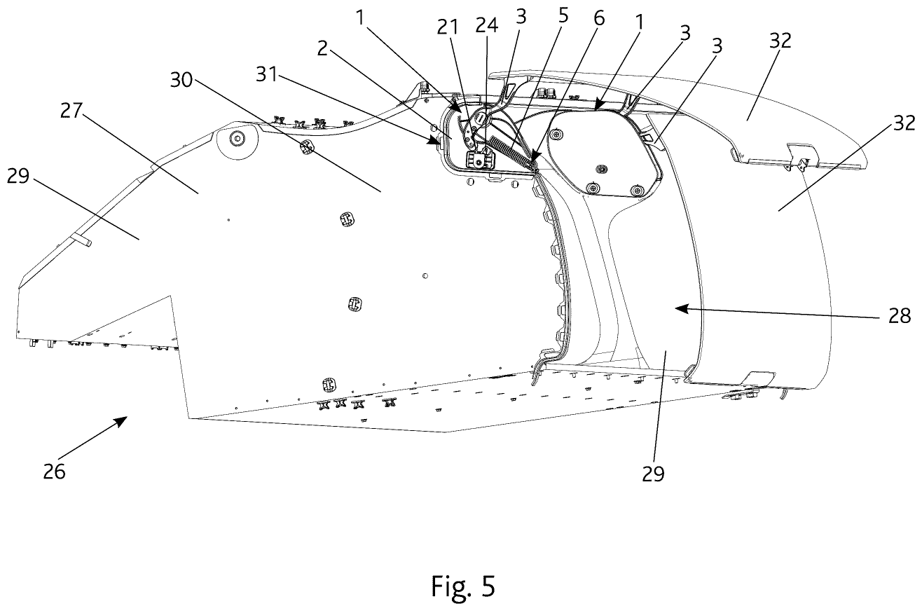

The spring element 5 comprises a linear tension spring, which is a wire spring. In particular, the spring section 5b is designed as a tension wire spring. The pivot axis 4 comprises a rotation damper. For further rotational damping, there is a toothed rim section 25 on the side cover plate 2, with which the lever arm 3 engages via a rotationally damped gear wheel. A stop element 21 (cf. FIG. 5) is provided against which the lever arm 3 abuts in the first pivot position. The stop element 21 is mounted on a leg spring and prevents the door from being moved beyond the open position by the spring element 5, as the torque exerted by the spring element 5 is less than that exerted by the stop element 21 and the gravitational force of the door. However, a user can apply additional force to move the door from the open position to an overpivot position in which it is further open than in the open position, whereby the lever arm 3 is pivoted from the first pivot position to an overpivot position and the stop element 21 is pivoted against the force of the leg spring. In the overpivot position, the lever arm 3 abuts against a further stop element 24, as shown in FIG. 1, which prevents the lever arm 3 from pivoting beyond the overpivot position.

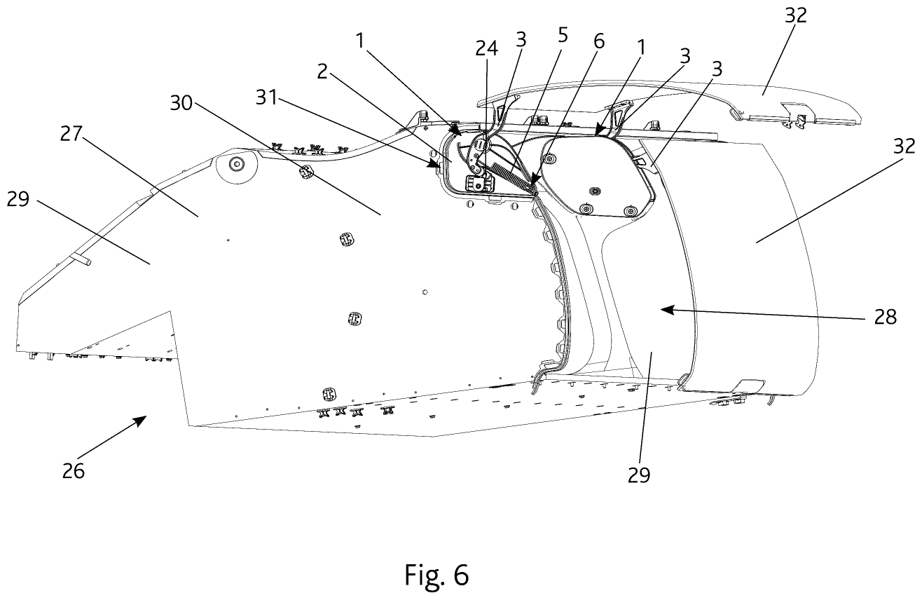

FIGS. 5 and 6 show an overhead luggage compartment 26 with a plurality of hinge assemblies 1 as described in context of FIGS. 1 to 4. The overhead luggage compartment 26 comprises a shell-shaped luggage compartment housing 27, which defines a storage space, with an insertion opening 28 through which the storage space can be loaded. The luggage compartment housing 27 comprises at least a first side element 29. The side element 29 comprises a side wall 30 and, adjacent to a portion of the perimeter 31 of the side wall, the hinge assembly 1. Furthermore, in this embodiment, the overhead luggage compartment 26 comprises two further (central) hinge assemblies 1 adjacent to the center of the upper perimeter of the insertion opening 28. The side cover plates 2 of these central hinge assembles 1 essentially delimit a space within which the lever arms 3 of the central hinge assemblies 1 are pivotably mounted. In addition, the overhead luggage compartment has a second side element 29, which also comprises a hinge assembly 1 (concealed in the figures) and which is opposite the first side element 29 with respect to the storage space. The lever arm 3 of the first side element 29 and the lever arm of the one central hinge assembly 1 support a door 32, which is movable between the closed position, in which the storage space is closed, and the open position, in which the storage space is accessible. In this embodiment, the door 32 is still movable into the overpivot position, as described in connection with FIGS. 1 to 4. This door 32 is shown in FIG. 5 in the open position, in which the lever arms 3 each abut against the stop element 21. In FIG. 6, the door 32 is shown in the overpivot position, in which the lever arms 3 have been pivoted against the force of the leg spring on which each stop element 21 is mounted, so that they each abut against the further stop element 24. The lever arm 3 of the second side element 29 and the lever arm of the other central hinge assembly 1 equally support a door 32. The latter is shown in the closed position in FIG. 5 and FIG. 6. If the weight of the respective door 32 is changed, the spring force acting on the respective lever arms 3 can be easily adapted to this using the adjustment element 6 of the respective hinge assemblies 1.

### REFERENCE SIGN LIST

1 Hinge assembly
2 Side cover plate
3 Lever arm
3a First arm element (at door)
3b Second arm element (at spring element)
4 Pivot axis
5 Spring element
5a First end (at nut)
5b Spring section
5c Connection section
6 Adjustment element
7 Adjustment unit
8 Perimeter of the side cover plate
9 Setscrew
10 Nut
11 Eye of the spring element (at nut)
12 Screw head
13 Counter element
14 End of the spring section on the connection section side
15 Spring force direction
16 Perimeter of the end of the spring section on the connection section side
17 Bushing
18 Pin
19 End of the spring element on the lever arm side
20 Eye of the spring element to the lever arm
21 Stop element
22 Spring axis
23 Circumferential cover
24 Further stop element
25 Toothed rim section
26 Overhead luggage compartment
27 Luggage compartment housing
28 Insertion opening
29 Side element
30 Side wall
31 Perimeter of the side wall
32 Door

1. A hinge assembly for a door of an overhead luggage compartment, comprising
a side cover plate,
a lever arm for supporting the door, which is connected to the side cover plate so as to be pivotable about a pivot axis and which is pivotable between a first pivot position, which corresponds to an open position of the door, and a second pivot position, which corresponds to a closed position of the door,
a spring element connected to the lever arm to support movement of the lever arm between the second pivot position and the first pivot position, and
an adjustment element with which a pretension of the spring element can be adjusted.

2. The hinge assembly according to claim 1, wherein the adjustment element comprises an adjustment unit with which the pretension of the spring element can be adjusted from outside a perimeter of the side cover plate.

3. The hinge assembly according to claim 1, wherein the adjustment element comprises a setscrew for adjusting the pretension of the spring element.

4. The hinge assembly according to claim 3, wherein the adjustment element comprises a nut with which the setscrew is engaged, wherein the spring element is connected to the nut.

5. The hinge assembly according to claim 4, wherein the spring element is formed at a first end as an eye in which the nut engages.

6. The hinge assembly according to claim 4, wherein the spring element at its first end engages around the nut on both sides of the setscrew.

7. The hinge assembly according to claim 3, wherein a rotary drive of a screw head of the setscrew is accessible from a direction essentially perpendicular to the side cover plate from outside a perimeter of the side cover plate.

8. The hinge assembly according to claim 7, wherein a counter element extends along a portion of the perimeter of the side cover plate essentially perpendicular to the side cover plate, wherein the screw head of the setscrew is supported on the counter element.

9. The hinge assembly according to claim 1, wherein the lever arm comprises a first arm element and a second arm element opposite the first arm element with respect to the pivot axis, wherein the first arm element is arranged to support the door and the spring element is connected to the second arm element.

10. The hinge assembly according to claim 1, wherein the spring element comprises a spring section and a straight connection section, wherein the connection section connects the spring section to the lever arm.

11. The hinge assembly according to claim 10, wherein the connection section is formed to be integral with the spring section.

12. The hinge assembly according to claim 10, wherein an end of the spring section on a side of the connection section comprises a perimeter in cross-section normal to the spring force direction, and the connection section extends from a region of the perimeter of the spring section that faces away from the pivot axis.

13. The hinge assembly according to claim 1, wherein the lever arm comprises a rotatably mounted bushing to which the spring element is connected.

14. The hinge assembly according to claim 13, wherein the bushing is rotatably mounted on a pin.

15. The hinge assembly according to claim 1, wherein the spring element comprises a tension spring.

16. The hinge assembly according to claim 1, wherein the spring element comprises a linear spring.

17. The hinge assembly according to claim 1, wherein the adjustment element is located in a spring axis of the spring element.

18. A side element for an overhead luggage compartment, comprising a side wall and, adjacent to a section of a perimeter of the side wall, the hinge assembly according to claim 1.

19. An overhead luggage compartment comprising a luggage compartment housing defining a storage space with an insertion opening through which the storage space can be loaded, wherein the luggage compartment housing comprises the side element according to claim 18, wherein the lever arm of the side element supports a door which is movable between the closed position, in which the storage space is closed, and the open position, in which the storage space is accessible.

20. An aircraft comprising the overhead luggage compartment according to claim 19.
